(19) United States
(12) Patent Application Publication
(10) Pub. No.: US 2014/0185651 A1
(43) Pub. Date: Jul. 3, 2014

(54) MERCURY FREE THERMOMETER

(71) Applicant: Gammon Technical Products, Inc., Manasquan, NJ (US)

(72) Inventors: James H. Gammon, Manasquan, NJ (US); Howard M. Gammon, Lakewood, NJ (US)

(21) Appl. No.: 14/143,091

(22) Filed: Dec. 30, 2013

Related U.S. Application Data
(60) Provisional application No. 61/746,955, filed on Dec. 28, 2012.

(51) Int. Cl. G01K 5/02

(52) U.S. Cl. CPC G01K 5/02
USPC 374/190; 29/592

(57) ABSTRACT

A liquid-in-stem thermometer includes a bulb configured to contain a thermometric fluid and a tube in fluid communication with the bulb. The tube has an inner surface. The liquid-in-stem thermometer further includes a layer of fluoropropyltrimethoxysilane. The layer of fluoropropyltrimethoxysilane is disposed on the inner surface of the tube. The thermometric fluid is saline water.

This application claims priority to U.S. Provisional Patent Application Ser. No. 61/746,955 filed Dec. 28, 2012, hereby incorporated herein by reference in its entirety.

### FIELD OF THE INVENTION

The present disclosure relates to a liquid-in-stem thermometer including a non-hazardous and a non-mercury thermometric fluid disposed in a tube with an interior surface coated with a liquid repellant chemical to militate against wetting.

### BACKGROUND OF THE INVENTION

As is commonly known, liquid-in-stem thermometers are advantageous for measuring temperatures of solids, liquids, and gases and consist of a column of thermometric fluid contained in a sealed glass tube. The tube typically has a temperature scale or gradient to visually indicate the temperature. As the temperature increases and decreases, the fluid in the thermometer expands and contracts, or rises and falls, within the tube, indicating the temperature. Advantageously, liquid-in-stem thermometers are easy to manufacture and are portable and easy to handle and use.

Mercury is a thermometric fluid typically used in liquid-in-stem thermometers. A surface tension of the mercury restricts the fluid along the inner surface of the glass tube causing the fluid to expand with a rounded surface, or convex meniscus, at a central axis of the glass tube. The convex meniscus of the fluid facilitates accurate measurements of temperature since a tip of the convex meniscus is easily viewable. Additionally, mercury does not adhere to, or wet, the glass tube. When a thermometric fluid wets the glass tube, the fluid adheres to the interior of the glass tube as the temperature decreases and causes the fluid to contract and fall within the glass tube. The adhesion of the fluid to the glass tube causes inaccurate readings of a temperature displayed by the thermometer.

However, mercury is known to be toxic and other alternate fluids are being used to replace mercury in liquid-in-stem thermometers. Other alternate fluids may not be as advantageous as mercury because the fluids wet the glass causing the fluid to form a concave meniscus at the center of the glass tube instead of a convex meniscus. The concave meniscus makes it difficult to accurately indicate the proper temperature displayed by the thermometer. In order to provide non-toxic, non-hazardous liquid-in-stem thermometers that can be read accurately, various non-hazardous and non-mercury liquids and anti-wetting methods are commonly used.

For example, U.S. Pat. No. 3,469,452 discloses a clinical thermometer having a non-metallic, non-wetting heat responsive liquid medium within a bore of the thermometer. A surface coating or film is disclosed as being provided within the bulb and along the total bore length of the thermometer. The coating applied to the bore could be a fluorocarbon, hydrocarbon, chlorocarbon, or nitrated hydrocarbon with low surface energy characteristics.

In another example, U.S. Pat. No. 7,246,942 discloses a liquid-in-stem thermometer that uses an aqueous solution rather than mercury as the thermometric fluid. An inner surface of a capillary bore is coated with a material. Fluorocarbon or silicon based polymers or copolymers can be used as the coating materials. Additionally, aliphatic or aromatic polyolefins, polyesters, polymethylmethacrylate, polycarbonates, aliphatic alkoxy silanes, or fluoroaliphatic alkoxy silanes can be used as coating materials.

Fluoropropyltrimethoxysilane is a chemical that can be used as an abrasion-resistant coating on solid substrates made of glass. However, non-mercury liquid-in-stem thermometers do not use a repellent chemical, fluoropropyltrimethoxysilane, to militate against anti-wetting. Additionally, the liquid-in-stem thermometers do not include depositing the fluoropropyltrimethoxysilane chemically in a gas phase to the thermometer to facilitate even coating and cost-effective application.

Therefore, there is a need for an accurate and inexpensive liquid-in-stem thermometer using a non-hazardous and non-mercury liquid wherein an interior surface of the thermometer militates against wetting. It would be advantageous if a non-mercury liquid-in-stem thermometer could be improved.

### SUMMARY OF THE INVENTION

Concordant and congruous with the present invention an improved liquid-in-stem thermometer using a non-hazardous and non-mercury liquid wherein an interior surface of the thermometer militates against wetting has surprisingly been discovered.

In one embodiment, a liquid-in-stem thermometer is disclosed. The liquid-in-stem thermometer includes a bulb configured to contain a thermometric fluid and a tube in fluid communication with the bulb. The tube has an inner surface. The liquid-in-stem thermometer further includes a layer of fluoropropyltrimethoxysilane disposed on the inner surface of the tube.

In another embodiment, a liquid-in-stem thermometer including a bulb configured to contain saline water and a tube in fluid communication with the bulb and having an inner surface is disclosed. The liquid-in-stem thermometer further includes a layer of a liquid repellant chemical disposed on the inner surface of the tube.

In yet another embodiment, a method of producing a non-mercury liquid-in-stem thermometer is disclosed. The method includes the steps of providing a tube in fluid communication with a bulb configured for containing a thermometric fluid; depositing a layer of fluoropropyltrimethoxysilane on an inner surface of the tube; and filling the bulb with the thermometric fluid.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is perspective view of a mercury free thermometer in accordance with an embodiment of the present invention; and

FIG. 2 is a cross-sectional view of a tube of the mercury free thermometer of FIG. 1 taken along line 2-2.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

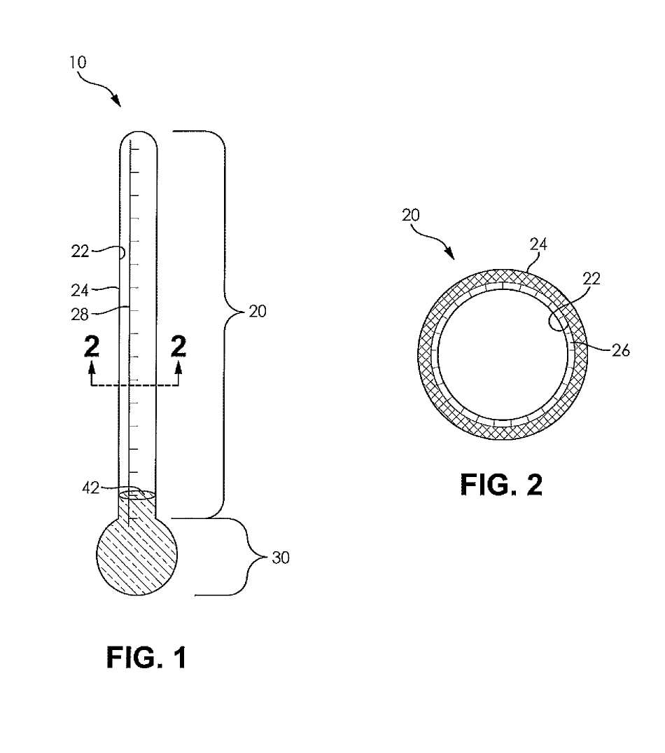

Referring to FIG. 1, a thermometer 10 for measuring temperatures is illustrated according to an embodiment. The thermometer 10 is a liquid-in-stem thermometer including a tube 20, a bulb 30, and a thermometric fluid 40. The thermometer 10 utilizes a variation in a volume, or thermal expansion and contraction, of the thermometric fluid 40 as the temperature increases or decreases to obtain a measurement of temperature.

The tube 20 is elongate and adapted as a reservoir for retaining and conveying the thermometric fluid 40 as the thermometric fluid 40 expands and contracts as the temperature changes. The tube 20 has a substantially cylindrical shape to facilitate precise measurements. Although, it is understood the tube 20 can have any shape as desired such as ovular, rectangular, or any other shape, as desired to facilitate precise measurements. Other features commonly associated with a liquid-in-stem thermometer can also be included as desired. For example, the liquid-in-stem thermometer 10 can include a capillary bore having a bore with a minimal internal diameter, a constriction chamber, a gas disposed adjacent the thermometric fluid 40, or a compression chamber, for example. The tube 20 can also include indicia 28 of a temperature scale, or gradient, to visually indicate the temperature. The indicia 28 can be disposed on a surface of tube 20 or proximate to the tube 20, such that, as the thermometric fluid 40 expands and contracts, a position of the thermometric fluid 40 aligns with the indicia 28 which corresponds to the temperature.

As illustrated in FIG. 2, the tube 20 further has an inner surface 22 and an outer surface 24. An inner layer 26 is disposed on the inner surface 22. The inner layer 26 is a liquid repellant chemical having an anti-wetting property, such as a low surface energy, militating against adhesion of the thermometric fluid 40 to the tube 20 as the thermometric fluid 40 expands and contracts in the tube 20. In the embodiment shown, the inner layer 26 is the liquid repellant chemical, fluoropropyltrimethoxysilane. Fluoropropyltrimethoxysilane is a fluorocarbon, that when used as a coating on glass, facilitates anti-wetting of non-mercury liquids, such as saline water. However, the inner layer 26 can be any fluorocarbon militating against adhesion of the thermometric fluid 40 to the tube 20. The inner layer 26 can be disposed on a portion of the inner surface 22 of the tube 20 or disposed on an entirety of the inner surface 22 of the tube 20.

The bulb 30 is adapted to be a reservoir for storing and retaining the thermometric fluid 40. The bulb 30 is in fluid communication with the tube 20, wherein the thermometric fluid 40 expands and flows from the bulb 30 along a length of the tube 20 as the temperature increases. As illustrated in the embodiment, the bulb 30 has a substantially spherical shape. However, the bulb 30 can have any shape as desired such as obround, tear-drop shaped, cube shaped, or any other shape as desired. It is understood the bulb 30 can also include the inner layer 26 of the liquid repellant chemical disposed on an inner surface thereof.

The thermometric fluid 40 is a non-hazardous and non-mercury liquid that has properties suitable for use in a thermometer for measuring and indicating temperature. The properties can include a large and uniform thermal expansion coefficient, thermal conductivity, and chemical stability. The thermometric fluid 40 shown is saline water, although it is understood that other materials can be used as desired such as mineral spirits, alcohol, other water or oil based fluids, or other non-hazardous fluids known now or later developed, for example. The thermometric fluid 40 can have a surface tension to militate against wetting when the thermometric fluid 40 interfaces with the inner layer 26. The thermometric fluid 40 can further include a colored dye material or pigment to facilitate viewing of the thermometric fluid 40 in the thermometer 10 to obtain precise measurements of temperature.

The tube 20 and the bulb 30 of the thermometer 10 can be formed from glass through a glass blowing and glass heating process or any other glass forming process as desired. The glass has a property that is sensitive to thermal changes. The tube 20 and the bulb 30 of the thermometer 10 can be formed from a composite of other materials such as plastic, metal, or a combination thereof, or any other material as desired. The thermometric fluid 40 is vacuum-sealed into the thermometer 10 through a vacuum-sealing process, although other processes could be used to dispose the thermometric fluid 40 within the thermometer 10.

In the embodiment shown, the inner layer 26 is applied to the inner surface 22 of the tube 20 through a gas phase process such as a chemical vapor deposition process. The application of the inner layer 26 to the inner surface 22 of the tube 20 occurs before the thermometric fluid 40 is disposed within the thermometer 10. To apply the inner layer 26 to the inner surface 22, the tube 20 is cleaned. The liquid repellant chemical is chemically deposited on the inner surface 22 of the tube 20 and heated. The heating disposes of undesired liquid repellent chemical to facilitate forming a substantially uniform distribution of the inner layer 26. It is understood the inner layer 26 can be applied to the interior surface 22 of the tube 20 using any method as desired, such as spray coating, roll coating, dip-coating or the like, for example.

In application, the thermometer 10 can be used to measure and indicate a temperature of solids, liquids, and gases. The thermometer 10 is used in applications in the fields of education, engineering, science, medicine, industry, and other fields, for example. The thermometers 10 can also be used domestically in households for various applications such as measuring the temperature of the atmosphere in a room in the home, measuring the temperature of a human body, measuring the temperature of food products, or any other application, as desired. Due to the non-hazardous thermometric fluid 40 such as saline water, the thermometer 10 can be used and disposed in a safe and environmental manner.

The thermometric fluid 40 in the tube 20 forms a surface 42 or meniscus. The surface 42 of the thermometric fluid 40 facilitates a precise measurement. As the temperature increases, a volume of the thermometric fluid 40 expands outwardly from the bulb 30 along a length of the tube 20. When the thermometric fluid 40 acquires an equilibrium, the surface 42 of the thermometric fluid 40 can be associated with the indicia 28 corresponding to the temperature. As the temperature decreases, the thermometric fluid 40 contracts inwardly towards the bulb 30. The inner layer 26 militates against a wetting of the inner surface 22 of the tube 20 by the thermometric fluid 40 as the thermometric fluid 40 expands or contracts within the tube 20. The inner layer 26 cooperates with the thermometric fluid 40 to militate against a wetting of the inner surface 22 of the tube 20 to form a substantially planar or convex surface 42 of the thermometric fluid 40.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A liquid-in-stem thermometer comprising:
a bulb configured to contain a thermometric fluid;
a tube in fluid communication with the bulb and having an inner surface; and
a layer of fluoropropyltrimethoxysilane disposed on the inner surface of the tube.

2. The liquid-in-stem thermometer of claim 1, wherein the thermometric fluid is mercury free.

3. The liquid-in-stem thermometer of claim 1, wherein the thermometric fluid is saline water.

4. The liquid-in stem thermometer of claim 1, wherein the bulb includes the layer of fluoropropyltrimethoxysilane.

5. The liquid-in-stem thermometer of claim 1, wherein the layer of fluoropropyltrimethoxysilane is chemically deposited on the tube.

6. The liquid-in-stem thermometer of claim 1, wherein the layer of fluoropropyltrimethoxysilane is deposited on the tube in a gas phase.

7. The liquid-in-stem thermometer of claim 1, wherein the layer of fluoropropyltrimethoxysilane is substantially uniform.

8. The liquid-in-stem thermometer of claim 1, wherein the thermometer is formed from glass.

9. A liquid-in-stem thermometer comprising:
a bulb configured to contain saline water;
a tube in fluid communication with the bulb and having an inner surface; and
a layer of a liquid repellant chemical disposed on the inner surface of the tube.

10. The liquid-in-stem thermometer of claim 9, wherein the liquid repellant chemical is fluoropropyltrimethoxysilane.

11. The liquid-in-stem thermometer of claim 10, wherein the layer of the repellant chemical is chemically deposited on the tube.

12. The liquid-in-stem thermometer of claim 10, wherein the layer of the repellant chemical is deposited on the tube in a gas phase.

13. The liquid-in-stem thermometer of claim 10, wherein the layer of the repellant chemical is substantially uniform.

14. The liquid-in stem thermometer of claim 9, wherein the bulb includes the layer of the liquid repellant chemical.

15. The liquid-in-stem thermometer of claim 9, wherein the thermometer is formed from glass.

16. A method of producing a non-mercury liquid-in-stem thermometer, comprising the steps of:
providing a tube in fluid communication with a bulb configured for containing a thermometric fluid;
depositing a layer of fluoropropyltrimethoxysilane on an inner surface of the tube; and
filling the bulb with the thermometric fluid.

17. The liquid-in-stem thermometer of claim 16, wherein the thermometric fluid is saline water.

18. The liquid-in-stem thermometer of claim 16, wherein the thermometric fluid is mercury free.

19. The liquid-in-stern thermometer of claim 16, wherein the thermometer is formed from glass.

20. The liquid-in-stem thermometer of claim 16, wherein the layer of fluoropropyltrimethoxysilane is chemically deposited on the inner surface of the tube in a gas phase.
